(19) United States
(12) Patent Application Publication
(10) Pub. No.: US 2012/0234129 A1
(43) Pub. Date: Sep. 20, 2012

(54) Breakaway Hand Guard

(76) Inventor: Andy Adan, Davis, CA (US)

(21) Appl. No.: 13/424,326

(22) Filed: Mar. 19, 2012

Related U.S. Application Data
(60) Provisional application No. 61/453,587, filed on Mar. 17, 2011.

(51) Int. Cl. B62K 21/12

(52) U.S. Cl. 74/551.8

(57) ABSTRACT

An improved hand guard assembly comprises a main body portion, a clamp, and an arm member. A hinge joint assembly pivotally connects the arm member to a second end of the main body portion. The clamp connects a handlebar to a first end of the main body portion. A coil spring of the hinge joint assembly restricts the free rotation of the arm member relative to the main body portion about a central axis. In a frontal accident or sudden deceleration of the vehicle, the operator's arms may hit the shield attached to the arm member in a forward direction imparting a forward force and rotating the arm member about the hinge joint assembly. The operator may then be thrown clear from the vehicle, preventing additional injuries that can occur when an operator's arms are caught between conventional hand guards and the handlebars.

### CROSS-REFERENCE TO RELATED APPLICATIONS

This application claims priority from the U.S. provisional application with Ser. No. 61/453,587, which was filed on Mar. 17, 2011. The disclosure of that provisional application is incorporated herein as if set out in full. Because Mar. 17, 2012 fell on a Saturday, this application submitted Mar. 19, 2012 should be considered timely.

### BACKGROUND OF THE INVENTION

1. Technical Field of the Invention

The present invention relates in general to safety hand guards for use by an operator of an off-highway vehicle (OHV). More specifically, the present invention improves the safety of hand guards for OHV operators by providing at least one hinged hand guard having reduced resistance to force applied from one direction, decreasing the risk of injury if the operator is thrown from the vehicle.

2. Background and Description of the Related Art

Hand guards for protecting the hands OHV operators are currently widely in use. The OHV operator normally encounters rough, uneven terrain, brush, small trees, and projectile debris from his/her own vehicle as well as from other vehicles around the operator's. The hands of the operator are generally on the handlebars of the vehicle and generally towards the front of the vehicle, and hence are particularly vulnerable to injuries that occur from brush, tree limbs, debris kicked up from other vehicles, and other objects that might be encountered while operating an off-highway vehicle. When objects hit the hands of the operator directly, especially at high speeds, injury may occur that causes the operator to release the handlebars, often leading to more serious injuries. To reduce hand injuries and resulting accidents, OHVs are often fitted with rigid hand guards or shields that protect the hands of the operator from impact against the above-mentioned objects.

Conventional hand guards or shields are rigidly mounted to the OHVs handlebars and incorporate separate arm and shield components with broad impact coverage. The arm of the conventional hand guard is attached to the handlebar, while the shield component is attached to this arm in front of the handlebar, providing space for the operator's hand and fingers between the handlebar and shield.

One critical drawback of existing hand guards is that, in a frontal accident wherein the forward momentum of the vehicle is quickly reduced, the operator may be thrown in the forward direction. When this occurs the, the operator's arms can become caught between the handlebar grip and the hand guard, preventing the operator from being cleanly thrown from the vehicle, potentially causing severe injury to the operator's arms as well as additional injuries if the operator is dragged or otherwise caught up or tangled in the space between handlebar and shield.

Several prior attempts have been made to manufacture protective hand guards that provide safety to the operator's hands. For background, reference is generally made to U. S. Pub. No. 2004/0173046 issued to Hancock et al., U.S. Pub. No. 2007/0039408 issued to Laivins et al., U.S. Pat. No. 4,141,567 issued to Scott, and U.S. Pat. No. 5,740,700 issued to Redmond. Each of the above disclosures describes a hand guard for protecting the hands of operators of off-highway vehicles. These hand guards are rigidly affixed to the ends of the handlebar and provide protection to the operator's hands from impacting physical objects. However, each of these hand guards suffers from the same drawback—namely that they may cause serious injury if the operator is not thrown clear over the handlebars and instead becomes trapped by his/her arm(s) in the space between the handlebars and guards.

Hence, it can be seen that there is a need for an improved hand guard comprising an adjustable shield rotatable in one direction, and providing for the operator an unobstructed pathway over the handlebars in the event of a frontal accident or sudden decrease in the forward momentum of the vehicle. Such an improved hand guard also provides adequate protection to the operator's hands from projectile debris and roadside brush during off-highway excursions.

### SUMMARY OF THE INVENTION

The present invention is an improved safety hand guard that provides additional safety features for increased protection to an OHV operator's hands, thereby allowing the operator to be thrown clear from the vehicle in the event of an accident.

The hand guard assembly comprises a main body portion having a first end and a second end, a clamping means having a plurality of holes and an arm member having a proximal end and a distal end. The arm member is pivotally connected to the second end of the main body portion by a hinge joint assembly. The clamping means connects an off-highway vehicle handlebar to the first end of the main body portion. The clamping means preferably comprises a plurality of holes, which are threaded internally, and which fix the hand guard assembly to the handlebar of an OHV using a fastening means. The second end of the main body portion comprises a groove to receive the hinge joint assembly. Preferably, a coil spring of the hinge joint assembly urges the arm member to a closed position and provides resistance in one direction against the free rotation of the arm member relative to the main body portion about a central axis.

In the event of a front-impact accident or sudden decrease in the forward momentum of the OHV, the operator's velocity or momentum is generally not slowed or reduced to a similar degree. Hence, the operator may continue in the forward direction at a greater speed than the rest of the OHV, and as a consequence may travel over the handlebars of the OHV. In the preferred embodiment of the present invention, if the operator's arms hit the shield in a forward direction the force from the operator's momentum overcomes the opposing force imparted by the coil spring, thereby allowing the arm member to rotate around the central axis of the hinge joint assembly, ultimately providing a clear path for the operator being thrown forward relative to the vehicle. The arm member and the shield rotate to change their orientation from a first position to a second position, so that the operator's arms will not become caught or tangled between the handgrip of the handlebar and the arm member or shield of the hand guard assembly. The second position is a pre-determined position allowing safe forward passage of the operator's arm. As a result, the operator may be thrown clear off the vehicle and reduce his/her risk of being caught in the hand shield and then and/or dragged by the OHV. Once the overcoming force provided by the operator is removed, the coil spring urges the arm member to return to the first position.

It is thus a first objective of the present invention is to provide an improved safety hand guard for an OHV.

A second objective of the invention is to provide an improved safety hand guard that allows the operator to be thrown clear from the OHV during a front-impact collision.

A third objective of the invention is to provide an improved OHV safety hand guard with an adjustable shield member.

These and other advantages and features of the present invention are described with specificity so as to make the present invention understandable to one of ordinary skill in the art.

### BRIEF DESCRIPTION OF THE DRAWINGS

In order to enhance the clarity and improve understanding of the various elements and the various embodiments of the invention, elements in the figures have not necessarily been drawn to scale. Furthermore, elements that are known to be common and well understood to those in the industry may not be depicted in order to provide a clear view of the various embodiments of the invention. Thus, the drawings are generalized in form in the interest of clarity and conciseness.

FIG. 1 illustrates a perspective view of a hand guard assembly attachable to a handlebar of an OHV;

FIG. 2 illustrates an exploded perspective view of the hand guard assembly;

FIG. 3 illustrates a perspective view of the hand guard assembly attached to the handlebar of the vehicle; and

FIG. 4 illustrates a perspective view of the two positions of the hand guard assembly attached to the handlebar of the vehicle.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently from one another or in combination with other features. However, any single inventive feature may not address any of the problems discussed above or only address one of the problems discussed above. Further, one or more of the problems discussed above may not be fully addressed by any of the features described below.

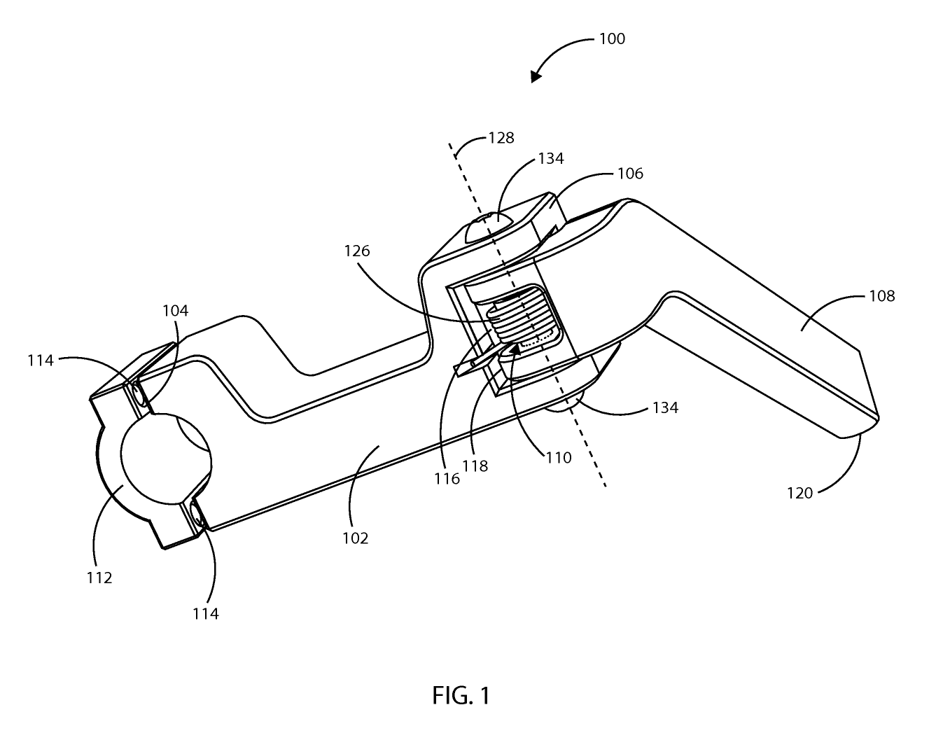

Turning first to FIG. 1, a perspective view of a hand guard assembly 100 attachable to a handlebar (not shown) of an OHV for providing safety to the hands of its operator is illustrated as an embodiment of the invention in its preferred form. Although in this exemplary embodiment, the improved hand guard is shown and described with respect to the operator of a motorcycle, it is to be understood that other off-highway vehicles with handlebars could similarly benefit from the application of the invention. Hence, in alternative embodiments the motorcycle may be replaced by track mounted vehicles such as a snowmobile, other two-, three-, and four-wheeled off-highway vehicles such as dirt bikes, motor scooters, all terrain vehicles and the like, referred to as a group for purposes of this application as “off-highway vehicles” (OHV). It is to be further understood that although one hand guard is shown, in an alternative embodiment at least two hand guards will be present on the OHV.

Continuing with FIG. 1, the hand guard assembly 100 comprises a main body portion 102 having a first end 104 and a second end 106, an arm member 108 pivotally connected to the second end 106, a hinge joint assembly 110 configured to connect the arm member 108 to the main body portion 102. The arm member 108 has a proximal end 118 and a distal end 120. A clamp 112 comprises a plurality of holes 114 for connecting the handlebar (not shown) to the first end 104 of the main body portion 102.

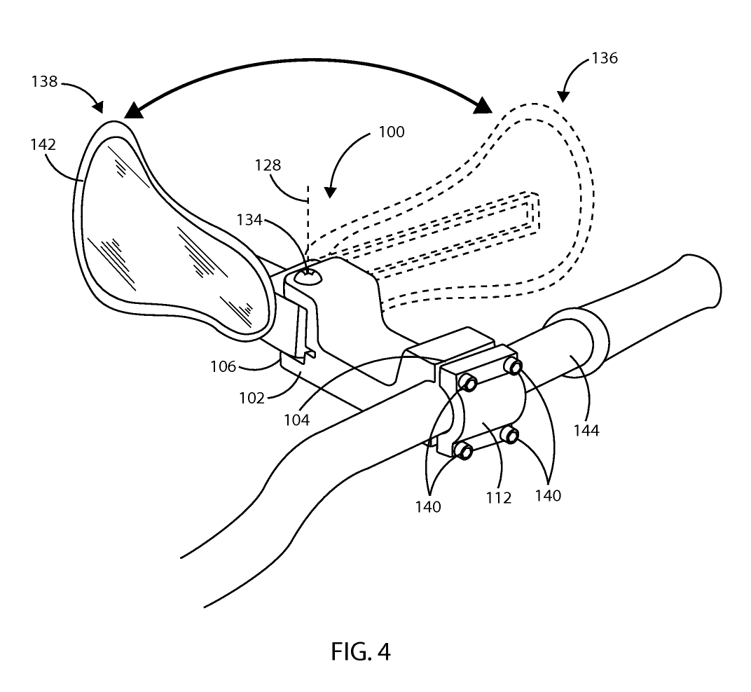

The first end 104 of the main body portion 102 is generally C shaped and has a plurality of threaded holes (not shown). The clamp 112 is generally C shaped and has a plurality of holes 114, which are threaded internally, for fixing the hand guard assembly 100 to the handlebar (not shown) of a vehicle using a fastening means (not shown). The second end 106 of the main body portion 102 has a groove 116 to receive the hinge joint assembly 110. The hinge joint assembly 110 pivotally connects the proximal end 118 of an arm member 108 to the second end 106 of the main body portion 102 using a pair of set screws 134. A coil spring 126 of the hinge joint assembly 110 restricts the free rotation of the arm member 108 relative to the main body portion 102 about a central axis 128, and as further described below urges the arm member 108 to remain in a first position 136 (see FIG. 4 and related text) unless force sufficient to overcome the spring tension is supplied.

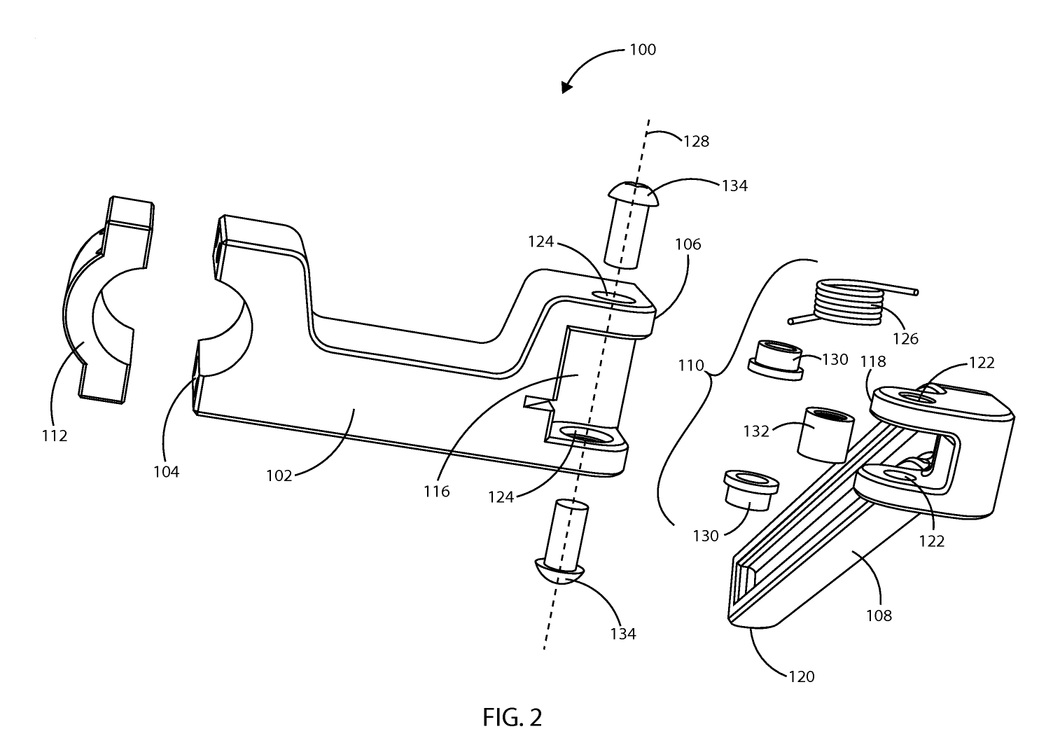

FIG. 2 illustrates an exploded perspective view of the hand guard assembly 100 in accordance with the preferred embodiment of the present invention. The hinge joint assembly 110 includes the coil spring 126 positioned around the central axis 128. A thread spacer 132 is positioned inside the coil spring 126. The pair of set screws 134 is adapted to engage the second end 106 of the main body portion 102 to the proximal end 118 of the arm member 108. A pair of bushings 130 is also used in the hinge joint assembly 110. Each one of the pair of bushings 130 are attached to a bottom end of each of the pair of set screws 134. The thread spacer 132 placed inside the coil spring 126 is positioned between the pair of bushings 130. The thread spacer 132 connects the pair of set screws 134 and ensures that the set screws 134 are extended properly and seat with the bushings 130, on top of the coil spring 126. All the above components are arranged as above to form the hinge joint assembly. The hinge joint assembly 110 is actuated by the coil spring 126 and enables the arm member 108 to rotate about the central axis 128.

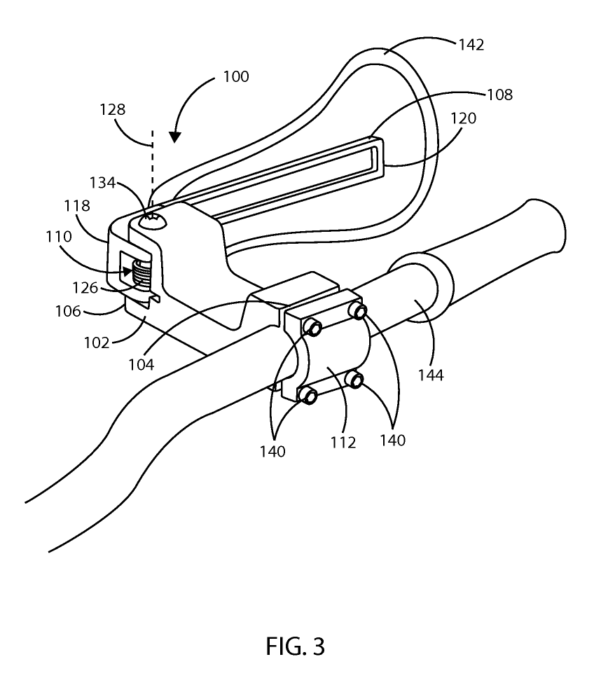

FIG. 3 illustrates a perspective view of the hand guard assembly 100 attached to a handlebar 144 of the vehicle. For mounting the hand guard assembly 100 to the handlebar 144 of the vehicle, the clamp 112 is attached to the first end 104 of the main body portion 102 using a fastening means 140. The fastening means 140 may any suitable known means in the art, such as screws or bolts with nuts. The screws are threaded through the plurality of threaded holes (not shown) of the first end 104 of the main body portion 102 and the plurality of holes 114 (labeled in FIG. 1) of the clamp 112. Thereby the hand guard assembly 100 is fixed and secured in place by threads to the handlebar 144.

The clamping means 112 and the first end 104 of the main body portion 102 being sized and shaped to receive a handgrip portion of the handlebar 144 to rigidly attach the hand guard assembly 100 to the handlebar 144. The arm member 108 of the hand guard assembly 100 includes a shield 142 configured to surround the perimeter of the arm member 108 and to protect the hand of the operator from injury caused by the rough, uneven terrain, brush, as well as projectile debris from other vehicles.

FIG. 4 illustrates a perspective view of the two positions of the hand guard assembly 100 attached to the handlebar 144 of the vehicle. The hands of the operator grasping the handlebar 144 of the vehicle are vulnerable to injuries while riding an OHV. When objects, brush or debris hit the hands of the operator directly, especially at high speeds, injury may occur that causes the operator to release the handlebars, often leading to more serious injuries. The hand guard assembly 100 is attachable to the handlebars 144 of the motorcycle, motor scooter, motorbike, and all terrain vehicles as shown. Under the above said riding conditions the shield 142 attached with the arm member 108 and remains in the first position 136 to protect the hands of the operator from sticks, stones, rocks or other projectiles thrown from vehicles in front of the operator.

In the event of a front-impact accident or sudden deceleration, the operator may be thrown over the handlebar 144 of the vehicle. (In practice the user is likely thrown over both handlebars but for purposes of simplicity only one is shown and described in this document). The hinge joint assembly 110 at the second end 106 of the hand guard assembly 100 allows the arm member 108 to be rotatable about the central axis 128 up to a pre-determined position. Preferably the axis of rotation is perpendicular to, though offset from, the axis of the handlebar. The hinge joint assembly 110 allows the arm member 108 to be adjusted between the first position 136 and a second position 138 when sufficient force to overcome the spring tension is supplied. In the event of a frontal accident or sudden deceleration where the operator's arm may hit the shield 142 attached to the arm member 108 in a forward direction, the arm may impart a forward force on the arm member 108. Where this forward force is of a sufficient level to overcome the spring tension, it exceeds the opposing force imparted by the coil spring 126 and the arm member 108 rotates about the central axis 128 of the hinge joint assembly 110. The arm member 108 and the shield 142 rotate to change their orientation from the first position 136 shown in phantom lines to the second position 138 shown in solid lines.

When the guard is in the second position 138, the gap in which the riders arm would in the prior art become caught is opened, and thereby prevents the operator's arm from being caught between the handgrip of the handlebar 144 and the arm member 108 or shield 142 of the hand guard assembly 100. Thereby the operator can be thrown clear from the OHV during a front-impact collision or sudden deceleration. The second position 138 is set a pre-determined amount of space away from said first position 136 preferably approximately equal to 90 degrees, as shown in FIG. 4.

After the force imparted by the rider is removed, the hinge joint assembly 110 will return to the first position 136 due to an opposing force offered by the coil spring 126. This opposing force will rotate the arm member 108 and the attached shield 142 from the second position 138 to the first position 136. The rotation of arm member 108 relative to the main body portion 102, which is fixed to the handlebar 144 of the OHV around a central axis 128 of the hinge joint assembly 110, is limited by the coil spring. To prevent unwanted rotation of the hand guard assembly 100 a locking mechanism is provided that may comprise an anti-rotation device. In one embodiment, a notch (not shown) is provided and is configured to accept a peg (not shown). Once the notch and the peg are aligned, rotation of the entire hand guard assembly 100 about the longitudinal axis of the handlebar 144 will not be possible. Other well-known means of locking the hand guard assembly 100 may be utilized.

The hand guard assembly 100 is preferably fixed to the handlebar 144 of the vehicle near the handgrip portion. The shield 142 is connected to the arm member 108. Under normal operating conditions the arm member 108 and the shield 142 remain in the first position 136. The hands of the operator holding the handgrip portion of the handlebar 144 is positioned in between the handlebar 144 and the arm member 108.

In an alternative embodiment of the invention the improved hand guard assembly is used in connection with a primarily on-highway motorcycle. Highway motorcycles often have mirrors in place of brush guards, and just as the rider's arms may become caught in the space behind the brush guards, the rider's arms may become caught in the space behind the mirrors. In these applications, the foldable brush guard assembly may be replaced with a foldable mirror assembly of the same configuration.

The foregoing description of the preferred embodiment of the present invention has been presented for the purpose of illustration and description. It is not intended to be exhaustive or to limit the invention to the precise form disclosed. Many modifications and variations are possible in light of the above descriptions. For example the spring loaded hinge assembly may be replaced with a magnetic hinge assembly. It is intended that the scope of the present invention not be limited by this detailed description, but by the claims and the equivalents to the claims appended hereto.

I claim:

1. A hand guard assembly attachable to a handlebar of an off highway vehicle and for protecting the hands of an operator of the off highway vehicle, the hand guard assembly comprising:
a main body portion having a first end and a second end;
a clamp connecting said main body portion to the handlebar of the off highway vehicle;
an arm member pivotally connected to the second end by a hinge joint assembly, the hinge joint assembly allowing the arm member to be rotatably adjusted about a central axis between a first position and a pre-determined second position; and
a hand guard integrated into said arm member.

2. The hand guard assembly of claim 1 wherein the hinge joint assembly is positioned between the second end of the main body portion and the proximal end of the arm member.

3. The hand guard assembly of claim 1 wherein the hinge joint assembly comprises a coil spring positioned around the central axis biasing said arm member in said first position.

4. The hand guard assembly of claim 3 wherein the coil spring resists free rotation of the arm member relative to the main body portion about the central axis.

5. The hand guard assembly of claim 1 wherein the hinge joint assembly is configured to provide a limited rotation joint that allows the arm member to be rotatable about the central axis from said first position to said pre-determined second position.

6. The hand guard assembly of claim 5 wherein the hinge joint assembly comprises a coil spring positioned around the central axis, urging said arm member in said first position.

7. The hand guard assembly of claim 5 wherein the limited rotation joint restricts the movement of the arm member between the first position and the second position.

8. The hand guard assembly of claim 5 wherein the coil spring resists free rotation of the arm member relative to the main body portion about the central axis.

9. The hand guard assembly of claim 8 wherein the coil spring urges said arm member in said first position.

10. The hand guard assembly of claim 9 wherein the coil spring returns said arm member to said first position when said arm member is moved to said pre-determined second position.

11. A hand guard assembly attachable to a handlebar of an off highway vehicle and for protecting the hands of an operator of the off highway vehicle, the hand guard assembly comprising:
a main body portion having a first end and a second end;
a clamp connecting said main body portion to the handlebar of the off highway vehicle;
an arm member pivotally connected to the second end by a hinge joint assembly, the hinge joint assembly positioned between the second end of the main body portion and the proximal end of the arm member allowing a limited rotation about a central axis from said first position to said pre-determined second position; and
a hand guard integrated into said arm member.

12. The hand guard assembly of claim 11 wherein the hinge joint assembly comprises a coil spring positioned around the central axis biasing said arm member in said first position.

13. The hand guard assembly of claim 12 wherein the coil spring resists free rotation of the arm member relative to the main body portion about the central axis.

14. The hand guard assembly of claim 12 wherein the coil spring biases said arm member in said first position.

15. The hand guard assembly of claim 14 wherein the coil spring returns said arm member to said first position when said arm member is moved to said pre-determined second position.

16. The hand guard assembly of claim 11 wherein the first position and the second position are approximately 90 degrees rotatably apart about the central axis.
